(19) United States
(12) Patent Application Publication
(10) Pub. No.: US 2009/0029591 A1
(43) Pub. Date: Jan. 29, 2009

(54) ELECTRICAL CONNECTOR AND ITS ASSEMBLY METHOD

(76) Inventor: Chin Chi Lin, Keelung City (TW)

Correspondence Address: SINORICA, LLC, 528 FALLSGROVE DRIVE, ROCKVILLE, MD, 20850, US

(21) Appl. No.: 11/955,551

(22) Filed: Dec. 13, 2007

(30) Foreign Application Priority Data
Jul. 26, 2007 (CN) 200710029382.0

(51) Int. Cl. H01R 13/40; H01R 43/00

(52) U.S. Cl. 439/586; 29/747

(57) ABSTRACT

An electrical connector and its assembly method, in which the electrical connector includes an insulator body and conductive terminals, wherein the insulator body has a first surface and a second surface and a plurality of through slots each including a first and a second terminal receiving slots, each conductive terminal including a first and a second sections respectively received within the first and the second terminal receiving slots, the second section being wider than the first terminal receiving slot, wherein the second section of each terminal and the sidewall of the second terminal receiving slot form a cooperating structure close to the second surface for preventing the withdrawing of the terminal from the through slot. According to the present invention, there is no need to provide several barbs on each terminal for pressed fitting with the insulator body. Thus, the walls of the insulator body will not be damaged.

### BACKGROUND OF THE INVENTION

1. Field of the Invention

This present invention relates to an electrical connector and its assembly method.

2. Brief Description of the Prior Art

In the conventional electrical connector, conductive terminals are generally retained in the insulator body of the conventional electrical connector by wedging engagement. That is to say, each terminal is provided with a holding section with several barbs disposed on both sides thereof for stabbing into corresponding walls of terminal receiving slots of the insulator body. The method of assembling the terminals into the insulator body by wedging engagement is easy, but the terminal receiving slots' walls will be easily damaged for the wedging engagement between the terminal and terminal receiving slot, therefore the terminals come away easily from the terminal receiving slot. This makes the fixing between the insulator body and the conductive terminals not stable.

Thus, a novel electrical connector and its assembly method is highly anticipated so as to improve the above defects.

### SUMMARY OF THE INVENTION

The object of this present invention is to provide an electrical connector which can hold the terminals firmly in the insulator body.

Another object of this invention is to provide an assembly method which can effectively fix the terminals in the insulator body.

In order to achieve the above objects, the electrical connector of the present invention comprises an insulator body and conductive terminals. Wherein the insulator body is provided with a first surface and a second surface opposite to the first surface, a plurality of through slots being provided between the first surface and the second surface. Each of the through slots includes a narrower first terminal receiving slot close to the first surface and a wider second terminal receiving slot close to the second surface. Each conductive terminal includes a first section received within the first terminal receiving slot and a second section received within the second terminal receiving slot The second section is wider than the first terminal receiving slot. The second section of each terminal and the sidewall of the corresponding second terminal receiving slot form a cooperating structure disposed at a location close to the second surface for preventing withdrawing of the terminal from the through slot.

In order to achieve the above object, the assembly method of the electrical connector of the present invention comprises the following steps of:
(1) providing a plurality of conductive terminals;
(2) providing an insulator body which is provided with a first surface, a second surface opposite to the first surface, a plurality of through slots between the first surface and the second surface, a melting glue area formed between the adjacent through slots on the second surface;
(3) inserting each conductive terminal into respective through slot of the insulator body;
(4) providing a pressing plate which is pressed against the melting glue area;
(5) heating the pressing plate such that the insulating material at both sides of the melting glue area is melted into colloid flowing toward the adjacent conductive terminals;
(6) cooling such that the cooperating structure for preventing the withdrawing of each terminal from the corresponding through slot is formed at the position close to the second surface.

During the assembly of the electrical connector in the present invention, because the cooperating structure for preventing the withdrawing of each terminal from the corresponding through slot is formed at the position close to the second surface, there is no need to provide several barbs on each terminal for fitting with the insulator body. Thus, the walls of the through slot of the insulator body will not be damaged, and the terminals can be effectively fixed within the insulator body so that normal use of the electrical connector can be assured.

### BRIEF DESCRIPTION OF THE ACCOMPANYING DRAWINGS

FIG. 1 is a partial sectional view of the electrical connector of the present invention.

FIG. 2 is a partial sectional view of the electrical connector as shown in FIG. 1 with the terminals being inserted in the insulator body of the electrical connector.

FIG. 3 is a partial sectional view showing the terminals of the electrical connector as shown in FIG. 2 being inserted in the insulator body.

FIG. 4 is a partial sectional view showing a pressing plate being disposed in the assembling process of the electrical connector as shown in FIG. 3.

FIG. 5 is a partial sectional view showing the pressing plate being heated in the assembling process of the electrical connector as shown in FIG. 4.

FIG. 6 is a partial sectional view of another embodiment of the electrical connector of the present invention.

### DETAILED DESCRIPTION OF THE PREFERRED EMBODIMENTS

The electrical connector and its assembly method of the present invention will be further described in detail by specific preferred embodiments in conjunction with accompanying drawings.

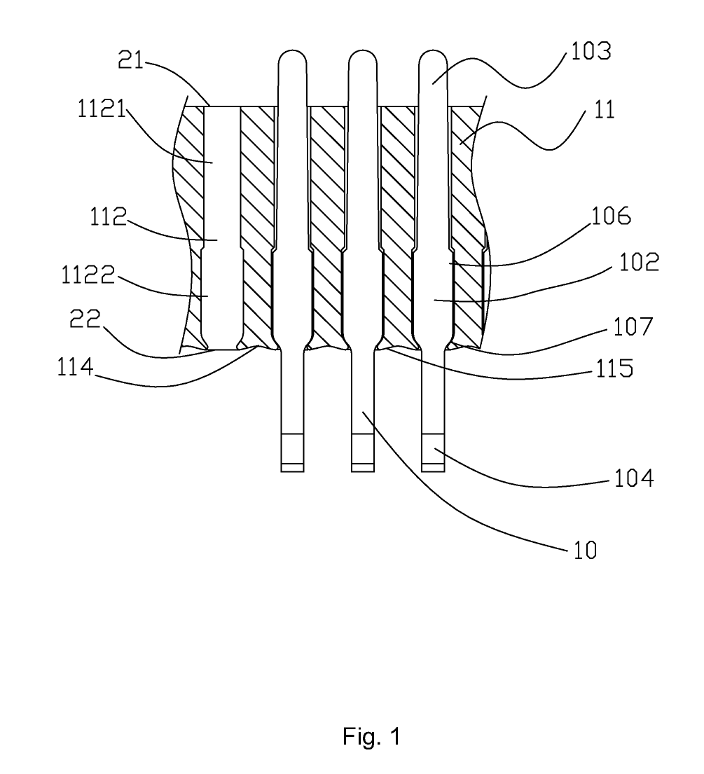

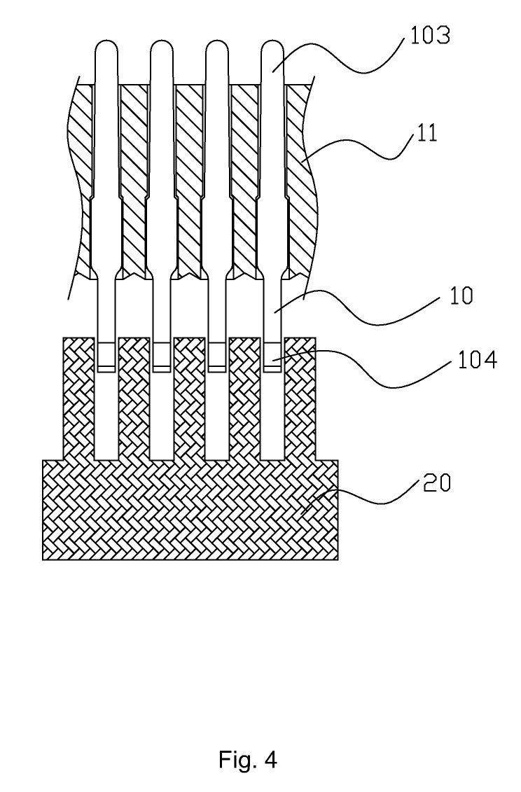

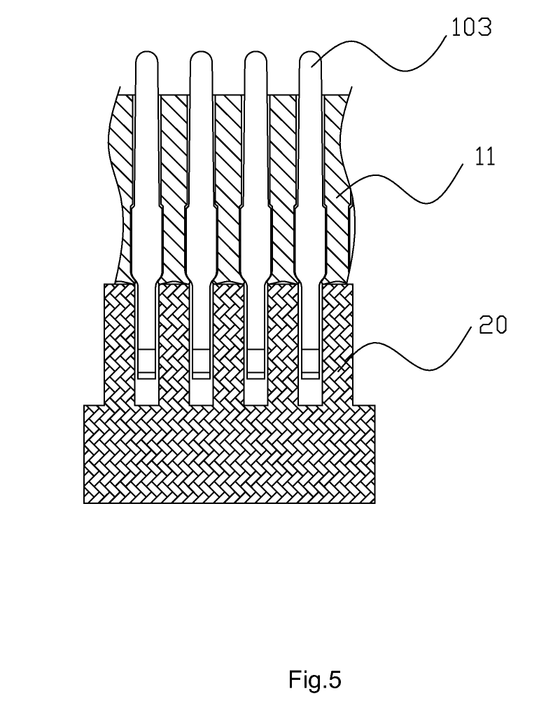

As shown in FIG. 1 to FIG. 6, the electrical connector of the present invention for electrically connecting an electronic component to a circuit board comprises an insulator body 11 provided with a plurality of through slots 112 and several conductive terminals 10 respectively received in the through slots 112.

The above insulator body 11 is provided with a first surface 21 and a second surface 22 opposite to the first surface 21. A plurality of through slots 112 are provided between the first surface 21 and the second surface 22. Each of the through slots 112 includes a narrower first terminal receiving slot 1121 close to the first surface and a wider second terminal receiving slot 1122 close to the second surface 22. Two projections 115 are provided between the adjacent through slots 112 on the second surface 22, and a recess 114 depressed toward the first surface 21 is provided at middle of the adjacent projections 115.

Each conductive terminal 10 comprises a second section (main body section 102), a first section (contact section 103) extending from one end of the main body section 102, and a soldering section 104 extending from the other end of the main body section 102. The main body section 102 of each terminal is provided with a protruding section 106 on both sides thereof. One end of the protruding section 106 terminates at a position where the main body section 102 connects the soldering section 104. A step face 107 is formed at the lower edge of the protruding section 106, in other word, the step surface 107 is formed at one end of the main body section 102, and this end of the main body section 102 connects with the soldering section 104.

After assembling, the main body section 102 is received within the second terminal receiving slot 1122, the contact section 103 is partially received within the first terminal receiving slots 1121, and the lower edge of the protruding section 106 faces toward the second surface 22 of the insulator body, that is, the step face 107 at the lower edge of the protruding section 106 faces toward the second surface 22 of the insulator body. The projection 115 abuts against the step face 107 at the lower edge of the protruding section 106 such that each terminal is prevented from withdrawing from the through slot 112. In this manner, the projection 115 and the step face 107 form a cooperating structure together which prevents each terminal from withdrawing from the through slot 112.

Certainly, the step face 107 is not necessarily located at the lower edge of the protruding section. Alternatively, a recessed section 101 is provided at the lower section of the main body section 102′ of each terminal and a step face 107′ is disposed at the upper edge of the recessed section 101. In this manner, the step face 107′ and the projection 115 can also form a cooperating structure together which prevents each terminal from withdrawing from the through slot 112.

In addition, each terminal can press-fit with the wall of the through slot at a location close to the second surface of the insulator body to prevents each terminal from withdrawing from the through slot, so that, there is no need to provide the terminals with any step face.

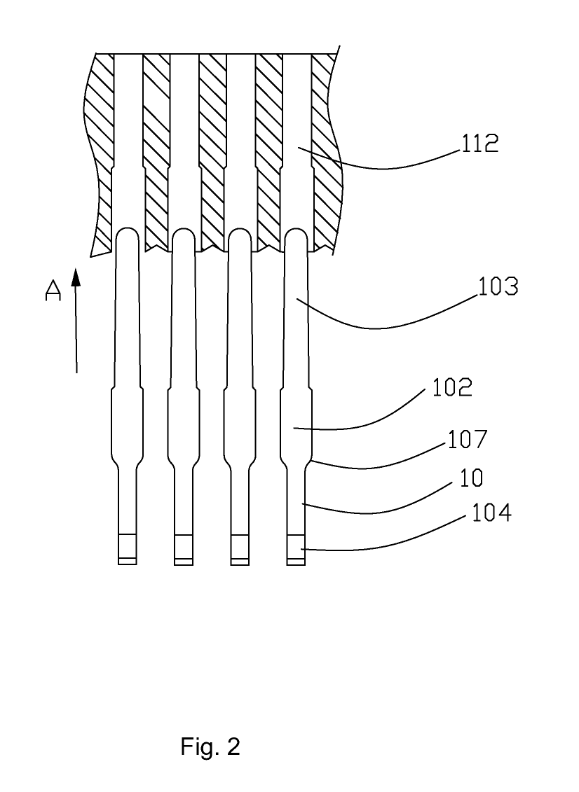

As shown in FIG. 2 to FIG. 5, the assembly steps of the above electrical connector will be described as follow.

Firstly, a plurality of conductive terminals 10 are provided. Each terminal 10 has a main body section 102, a contact section 103 extending from the main body section 102 and a soldering section 104. A step face 107 is formed at one end of the main body section 102 and this end of the main body section 102 connects with the soldering section 104 (as shown in FIG. 1).

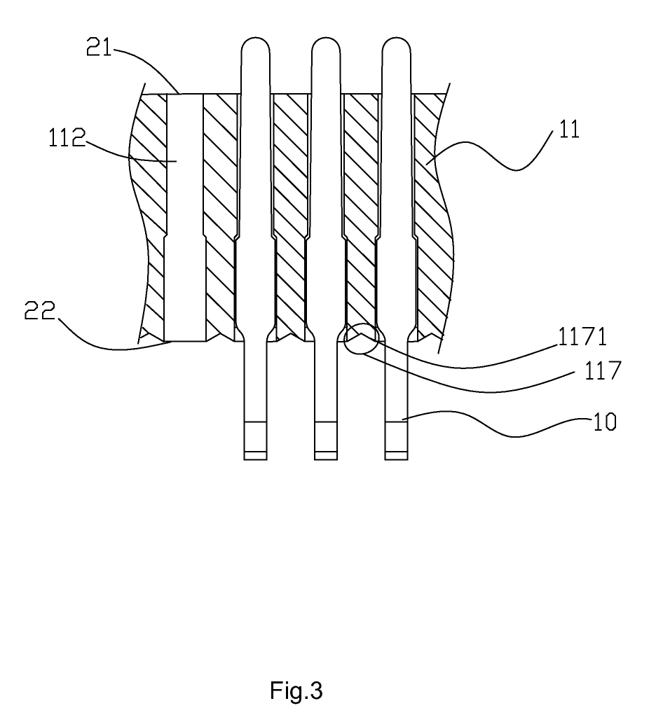

Next, an insulator body is provided. The insulator body has a first surface 21 and a second surface 22 opposite to the first surface 21. A plurality of through slots 112 are provided between the first surface 21 and the second surface 22. A melting glue area 117 is formed between the adjacent through slots 112 on the second surface, and a projecting block 1171 adjacent to the through slot 112 is provided in the melting glue area 117. The projecting block's side is coplanar with the corresponding sidewall of the adjacent through slot 112 (as shown in FIG. 3).

Next, the contact section 103 of each conductive terminal 10 is inserted into the through slot 112 from the second surface 22 of the insulator body 11 along the direction A (as shown in FIG. 2) and the top end of the contact section 103 is exposed outside the first surface 21.

Then, a pressing plate 20, which is a heating plate, is provided to press against the melting glue area 117 of the insulator body 11. Heat is applied to the pressing plate 20 and transfers from the heating plate to the projecting block 1171 via the contact surface between the two. Then, the projecting block 1171 is melted into colloid flowing toward the step face 107. Because of the existence of the projecting block 1171, the melting of the projecting block 1171 can be realized without high temperature and long heating duration, and the cost and the time for melting the projecting block 1171 can be reduced. Furthermore, as the projecting block's 1171 side is coplanar with the corresponding sidewall of the adjacent through slot 112 (as shown in FIG. 3), the colloid will transversally flow toward the adjacent through slot and more colloid can be attached to the step face 107.

Then, the electrical connector is cooled down, and the insulator body 11 forms projections 115 abutting against the step face 107 of each terminal 10 at a location close to the second surface. The projection and the step face 107 form a cooperating structure together which prevents each terminal from withdrawing from the through slot.

Thus, the assembly of the electrical connector is completed.

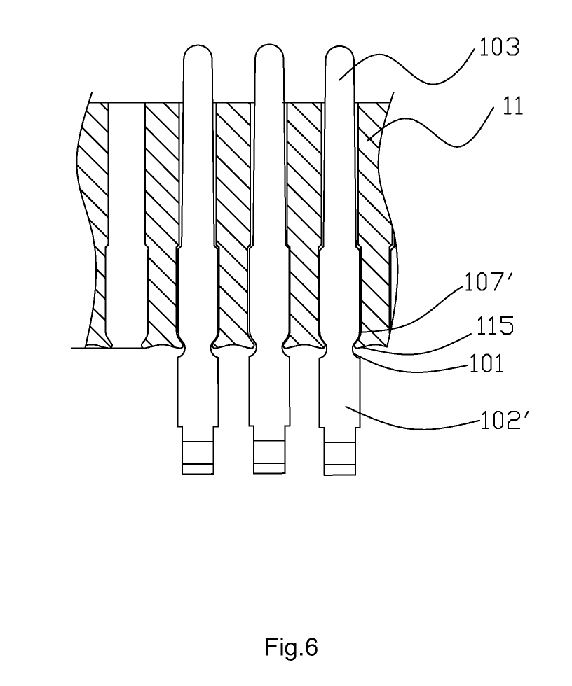

Based on the foregoing statement, the step face can be provided either at the lower edge of the protruding section of the main body section 102 or at the upper edge of the recessed section (as shown in FIG. 6). Alternatively, there is even no need to provide the step face (for example, each terminal can press-fit directly with the walls of the through slot at a location close to the second surface of the insulator body), if a cooperating structure for preventing each terminal from withdrawing from the through slot is provided at a location close to the second surface of the insulator body, each terminal can be effectively fixed within the insulator body and no damage will be happened to the wall of the insulator body.

Summing up above, the present invention is in conformity with the requirement for a patent, and a patent application is hereby submitted. It is also noted that the abovementioned preferred embodiment is purely for the convenience of description only, not intended to be restrictive on the scope of the present invention. Any modifications and variations or the equivalents developed without departing from the spirit and principle of the present invention is considered to be still within the scope of the present invention.

1. An electrical connector comprising:
an insulator body provided with a first surface, a second surface opposite to the first surface, a plurality of through slots provided between the first surface and the second surface and with a narrower first terminal receiving slot close to the first surface and a wider second terminal receiving slot close to the second surface; and
a plurality of conductive terminals respectively received in the corresponding through slot, and comprising a first section received within the first terminal receiving slot and the second section received within the second terminal receiving slot, said second section being wider than said first terminal receiving slot;
wherein the insulator body is integrated:
wherein the second section of each terminal and the sidewall of the second terminal receiving slot form a cooperating structure together at a position close to the second surface for preventing the withdrawing of the terminals from the through slot, said cooperating structure including a step face disposed on the second section of each terminal, located at a position close to the second surface, and a projection disposed on the sidewall of said second terminal receiving slot, abutting against said step face, the projection formed by melting and extrusioning the insulator.

2. (canceled)

3. An electrical connector as claimed in claim 1, wherein each terminal is provided with a recessed section at a location close to the second surface, said step face is located at the end of the recessed section away from said second surface.

4. An electrical connector as claimed in claim 1, wherein said cooperating structure includes a projection disposed on the second section of each terminal and provided at a location close to the second surface, said step face is located at the end of said projection and faces toward the second surface.

5. An electrical connector as claimed in claim 1, wherein the number of said projections on the second surface between the adjacent through slots is two, and a recess depressed toward the first surface is provided between said two projections.

6. An electrical connector as claimed in claim 1, wherein said second section of said conductive terminal is the main body section; said first section of said conductive terminal is the contact section extending from one end of the main body section; a soldering section is formed by extending from the other end of the main body section; and said step face is located at one end of the main body section and the end of the main body connects with the soldering section.

7-11. (canceled)
